(19) United States
(12) Patent Application Publication
(10) Pub. No.: US 2010/0017823 A1
(43) Pub. Date: Jan. 21, 2010

(54) ELECTRONIC DEVICE AND METHOD OF CREATING A SEQUENCE OF CONTENT ITEMS

(75) Inventors: Bartel Marinus Van De Sluis, Eindhoven (NL); Adolf Proidl, Eindhoven (NL)

Correspondence Address: GRADY K. BERGEN, 3333 LEE PARKWAY, SUITE 600, DALLAS, TX, 75219, US

(73) Assignee: KONINKLIJKE PHILIPS ELECTRONICS, N.V., EINDHOVEN (NL)

(21) Appl. No.: 11/993,511

(22) PCT Filed: Jun. 28, 2006
(86) PCT No.: PCT/IB2006/052161

§ 371 Date: Dec. 21, 2007

(30) Foreign Application Priority Data
Jun. 30, 2005 (EP) 05105895.6

(51) Int. Cl. H04N 5/445

(52) U.S. Cl. 725/46

(57) ABSTRACT

The method of creating a sequence of content items of the invention comprises determining similar content items (P6, P12, P21, P23, P24, P26) from a plurality of content items (P1-P26) and creating a sequence (47) of said similar content items in dependence on at least one of a total duration and amount of said similar content items exceeding a certain threshold. The electronic device of the invention comprises electronic circuitry which is operative to perform the method of the invention. The software of the invention enables a programmable device to perform the method of the invention.

The invention relates to a method of creating a sequence of content items, e.g. TV or radio programs.

The invention also relates to software for making a programmable device operative to perform a method of creating a sequence of content items.

The invention further relates to an electronic device comprising electronic circuitry, the electronic circuitry being operative to create a sequence of content items.

The invention also relates to electronic circuitry for use in an electronic device, the electronic circuitry being operative to create a sequence of content items.

An example of such an electronic device is known from US2003/0126600. The invention described in US2003/0126600 relates to a data management system for creating a personalized content information channel for an end-user. The system allows e.g. automatically playing out a plurality of concatenated content information segments, or programs, selected on the basis of a criterion independent of a respective resource of respective ones of the programs. The concatenation allows a substantially continuous, or back-to-back, play-out as if the personalized channel were a conventional TV or radio channel. It is a drawback of this data management system that users need to set up their personalized (virtual) channels manually, which can take quite some effort.

It is a first object of the invention to provide an electronic device of the type described in the opening paragraph, which does not require a user to define a criterion for selecting content items for inclusion in the sequence of content items.

It is a second object of the invention to provide a method of the type described in the opening paragraph, which does not require a user to define a criterion for selecting content items for inclusion in the sequence of content items.

According to the invention, the first object is achieved in that the electronic circuitry is operative to determine similar content items from a plurality of content items, said similar content items having at least one similar characteristic, and create a sequence of said similar content items in dependence on at least one of a total duration and amount of said similar content items exceeding a certain threshold. A new sequence can thereby be automatically created or creation of a new sequence can be automatically suggested when sufficient content is available that has at least one similar characteristic. The new sequence can be automatically removed or removal of the new sequence can be automatically suggested when sufficient content that has the at least one similar characteristic is no longer available. A user thus no longer has to define criteria for selecting content items for inclusion in the sequence of content items. The invention is based on the recognition that a user would want to choose from dissimilar content rather than choose from similar content.

In an embodiment of the electronic device of the invention, the plurality of content items comprises currently available content items. Currently available content items may comprise programs that are available for downloading/video-on-demand and match a user's preferences and/or programs that have been recorded from, for example, broadcast TV. In addition to currently available programs, the plurality of content items may also comprise forthcoming programs, e.g. programs that are scheduled to be recorded.

The electronic circuitry may be operative to present the sequence of said similar content items as a virtual channel. In a relatively straightforward embodiment, sequences of stored content items are listed together with individual, stored content items in a single overview. However, many users are used to the concept of channels and it is therefore advantageous to present the sequence of similar content items as a virtual channel. The user may be allowed to ‘zap’ to the virtual channel, e.g. by using number buttons and/or channel up and/or down buttons on a remote control. Alternatively or additionally, the virtual channel may be listed in an electronic program guide (EPG) among broadcast channels. User tests have shown that a virtual channel which comprises an ordered playlist of (partial) television programs that is mapped to one particular preset is appreciated by consumers.

The at least one similar characteristic may comprise a title. Content items with a similar title are likely to be episodes in a series of content items. It is likely that a user will want to watch the first episode (e.g. for soaps) or last episode (e.g. for news programs) in the series of episodes. The recording date can be used to order the content items in the sequence of content items. Alternatively, if the program guide data contains episode information (e.g. ‘episode 3 of season 2’), this can be used to order the content items in the sequence of content items.

The at least one similar characteristic may comprises a genre, a cast member and/or a description. This could advantageously facilitate the creation of a virtual ‘Science Fiction’ channel, a virtual ‘Paul Verhoeven’ channel, a virtual ‘Rutger Hauer’ channel and/or a virtual ‘Boston’ channel (e.g. containing TV programs such as ‘The Practice’, ‘Boston Legal’ and ‘Boston Public’).

The content items preferably comprise TV programs (i.e. video content). Although the content items may also comprise, for example, songs (e.g. for automatically creating a playlist with romantic songs if enough romantic songs are available), the invention is most useful when used with content that is consumed only once and then deleted.

According to the invention, the second object is achieved in that the method comprises the steps of determining similar content items from a plurality of content items, said similar content items having at least one similar characteristic, and creating a sequence of said similar content items in dependence on at least one of a total duration and amount of said similar content items exceeding a certain threshold.

In an embodiment, the method of the invention further comprises the step of presenting the sequence of said similar content items as a virtual channel.

These and other aspects of the method and electronic device of the invention will be further elucidated and described with reference to the drawings, in which:

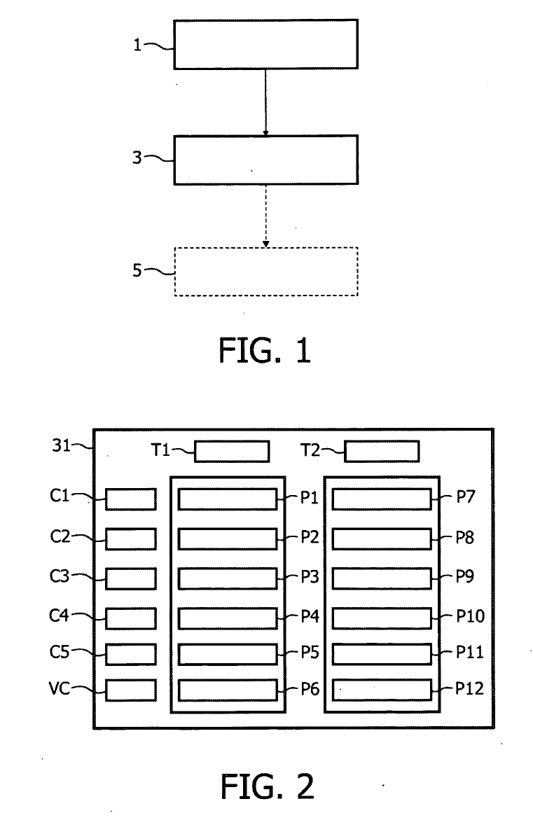

FIG. 1 is a flow diagram of the method of the invention;

FIG. 2 shows an example of a now-next program guide at a first time instance;

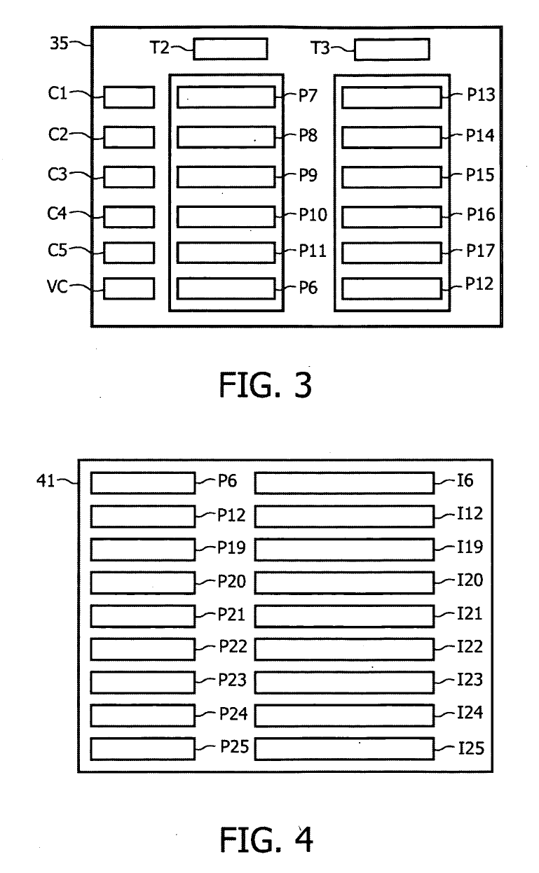

FIG. 3 shows an example of the now-next program guide of FIG. 2 at a second time instance;

FIG. 4 shows an example of an inventory of available programs before creation of a sequence;

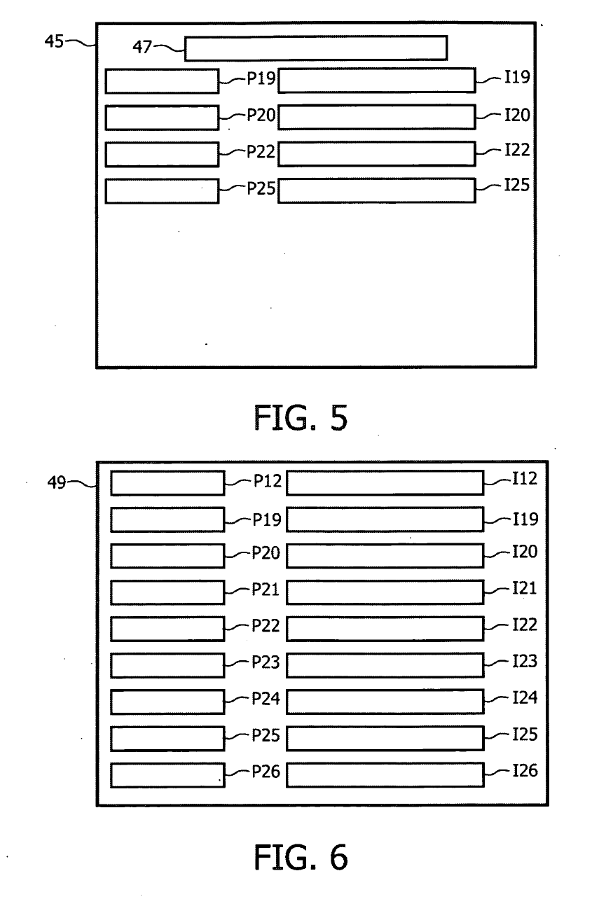

FIG. 5 shows an example of the inventory of available programs of FIG. 4 after creation of a sequence;

FIG. 6 shows an example of the inventory of available programs of FIG. 5 after deletion of the sequence; and

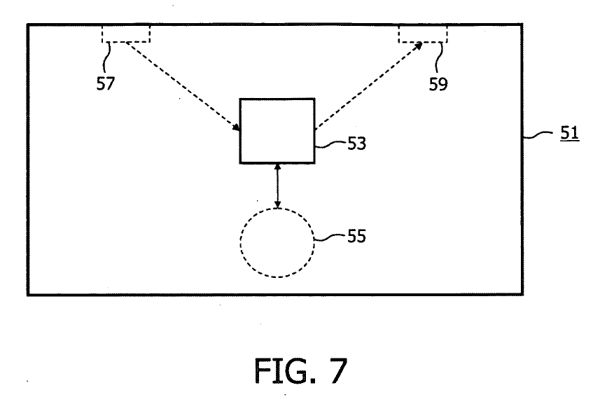

FIG. 7 is a block diagram of the electronic device of the invention.

Corresponding elements within the drawings are identified by the same reference numerals.

Referring to FIG. 1, the method of creating a sequence of content items of the invention comprises at least two steps. A step 1 comprises determining similar content items from a plurality of content items, said similar content items having at least one similar characteristic. A step 3 comprises creating a sequence of said similar content items in dependence on at least one of a total duration and amount of said similar content items exceeding a certain threshold. The method may further comprise a step 5 of presenting the sequence of said similar content items as a virtual channel.

A first embodiment of the method of the invention is illustrated in FIGS. 2 and 3. In FIG. 2, a virtual channel VC is displayed on a screen 31 of a ‘now-next’ electronic program guide (EPG) at or around a time T1. In addition to the virtual channel VC, five regular channels C1-C5 are displayed. At or around a first time T1, programs P1-P5 are broadcast on channels C1-C5, respectively. At or around a second time T2, programs P7-P11 are broadcast on channels C1-C5, respectively. Programs P6 and P12 are not broadcast live, but are stored content items with at least one similar characteristic. At least program P6 can be selected for immediate reproduction. After program P6 has ended, program P12 will be automatically reproduced.

FIG. 3 shows a screen 35 of the EPG of FIG. 2 at or around the time T2. At or around a third time T3, programs P13-P17 are broadcast on channels C1-C5, respectively. As the user has not yet watched program P6 (nor program P12), programs P6 and P12 are still displayed in the EPG.

A second embodiment of the method of the invention, which may be implemented in the same EPG that implements the first embodiment, is illustrated in FIGS. 4, 5 and 6. In FIG. 4, a screen 41 lists nine programs P6, P12 and P19-P25. Each program can be selected for reproduction by a user (e.g. by moving a cursor and pressing an ‘ok’ button). Information fields I6, I12 and I19-I25 list information with respect to the corresponding programs. In FIG. 5, a new program P26 has been recorded, which has a similar characteristic as programs P6, P12, P21, P23 and P24. Since the amount of programs exceeds a threshold 6 (e.g. a user-defined threshold), a sequence 47 is automatically created. Screen 45 lists sequence 47 and the non-sequenced programs P19, P20, P22 and P25. The sequence 47 can be selected for reproduction by the user, similar to the selection of the individual programs. After selection of the sequence 47, first, program P6 will be reproduced. After program P6 has ended, programs P16, P12, P21, P23, P24 and P26 will be automatically reproduced in sequence, unless they are stopped by the user. If a program has been watched, it will be removed from the sequence (and possibly from its storage means). Optionally, if the number of programs in sequence 47 again becomes smaller than 6, sequence 47 is automatically removed. This is illustrated in FIG. 6, in which program P6 has been completely reproduced. Screen 49 of FIG. 6 lists the same programs as screen 41 of FIG. 4, except that P6 has been removed and P26 has been added. Optionally, the EPG may first ask the user whether he agrees with the automatic creation (and, if used, with the automatic removal) of a sequence of content items.

Referring to FIG. 7, the electronic device 51 of the invention comprises electronic circuitry 53. The electronic circuitry 53 is operative to determine similar content items from a plurality of content items, said similar content items having at least one similar characteristic, and create a sequence of said similar content items in dependence on at least one of a total duration and amount of said similar content items exceeding a certain threshold.

The electronic device 51 may be, for example, a server PC, a stationary audio and/or video player (e.g. a home PC) or a portable audio and/or video player. The electronic device 51 may be, for example, a personal video recorder or a video-on-demand set-top box, possibly integrated into a TV. The electronic circuitry 53 may be a general-purpose processor (e.g. Intel Pentium or AMD Athlon) or an application-specific processor (e.g. a Philips Nexperia IC). The electronic device 51 may further comprise a storage means 55, an input 57 and an output 59. The storage means 55 may comprise, for example, volatile or non-volatile RAM, a hard disk, an optical disc and/or a holographic storage medium. The content items and/or the sequence of the content items may be stored on the storage means 55. The sequence of the content items may be stored, for example, as a text file that comprises an ordered list of TV program identifiers. Although possible, it is not necessary to store the content items in the sequence as one larger content item on the storage means 55. The input 57 may comprise, for example, an RF receiver, SCART, composite, component, DVI and/or HDMI input. The output 57 may comprise, for example, a wireless transmitter, SCART, composite, component, DVI and/or HDMI output. The output 57 may additionally or alternatively comprise a reproduction means for reproducing the content items in the created sequence, e.g. a display. The input 57 and/or the output 59 may comprise one or more network adapters connected to a home network and/or to the Internet. For example, the output 59 of a server PC may be used to transfer a TV program, program guide data and/or the sequence of content items (e.g. a text file/message) to the input 57 of a consumer electronic device, e.g. a home PC.

While the invention has been described in connection with preferred embodiments, it will be understood that modifications thereof within the principles outlined above will be evident to those skilled in the art, and thus the invention is not limited to the preferred embodiments but is intended to encompass such modifications. The invention resides in each and every novel characteristic feature and each and every combination of characteristic features. Reference numerals in the claims do not limit their protective scope. Use of the verb “comprise” and its conjugations does not exclude the presence of elements or steps other than those stated in the claims. Use of the article “a” or “an” preceding an element or step does not exclude the presence of a plurality of such elements or steps.

As will be apparent to a person skilled in the art, ‘means’ are understood to include any hardware (such as separate or integrated circuits or electronic elements) or software (such as programs or parts of programs) which perform in operation or are designed to perform a specified function, be it solely or in conjunction with other functions, be it in isolation or in co-operation with other elements. The invention can be implemented by means of hardware comprising several distinct elements, and by means of a suitably programmed computer. ‘Software’ is to be understood to mean any software product stored on a computer-readable medium, such as a floppy disk, downloadable via a network, such as the Internet, or marketable in any other manner.

1. An electronic device (51) comprising electronic circuitry (53), the electronic circuitry being operative to:
determine similar content items (P6, P12, P21, P23, P24, P26) from a plurality of content items (P1-P26), said similar content items having at least one similar characteristic; and
create a sequence (47) of said similar content items in dependence on at least one of a total duration and amount of said similar content items exceeding a certain threshold.

2. The electronic device as claimed in claim 1, wherein the plurality of content items comprises currently available content items (P6, P12, P19-P26).

3. The electronic device as claimed in claim 1, wherein the electronic circuitry is operative to present the sequence (47) of said similar content items as a virtual channel (VC).

4. The electronic device as claimed in claim 1, wherein the at least one similar characteristic comprises a title.

5. The electronic device as claimed in claim 1, wherein the at least one similar characteristic comprises a genre, a cast member and/or a description.

6. The electronic device as claimed in claim 1, wherein the content items are TV programs.

7. The electronic circuitry of claim 1.

8. A method of creating a sequence of content items, the method comprising the steps of:
determining (1) similar content items from a plurality of content items, said similar content items having at least one similar characteristic; and
creating (3) a sequence of said similar content items in dependence on at least one of a total duration and amount of said similar content items exceeding a certain threshold.

9. The method as claimed in claim 8, further comprising the step of presenting (5) the sequence. of said similar content items as a virtual channel.

10. Software for making a programmable device operative to perform the method of claim 8.
